(19) United States
(12) Patent Application Publication
(10) Pub. No.: US 2025/0184594 A1
(43) Pub. Date: Jun. 5, 2025

(54) IMAGING APPARATUS, METHOD OF CONTROLLING THE SAME, AND STORAGE MEDIUM

(71) Applicant: CANON KABUSHIKI KAISHA, Tokyo (JP)

(72) Inventor: SHINJIRO TAKAMI, Kanagawa (JP)

(21) Appl. No.: 18/965,902

(22) Filed: Dec. 2, 2024

(30) Foreign Application Priority Data
Dec. 5, 2023 (JP) 2023-205387

(51) Int. Cl. H04N 23/61

(52) U.S. Cl. CPC H04N 23/61

(57) ABSTRACT

An imaging apparatus includes a detection unit configured to perform detection for detecting at least one of an object which is carried away and an object which is left behind, a reception unit configured to receive, from an external device, a setting command regarding the detection, and a setting unit configured to set, based on the setting command received by the reception unit, a parameter that is used when the detection unit performs the detection, wherein the setting unit is configured to use a value of a first parameter included in the setting command to set a second parameter that is used when the detection unit performs the detection and that is different from the first parameter.

### BACKGROUND

### Field of the Disclosure

The present disclosure relates to an imaging apparatus, a method of controlling the imaging apparatus, and a storage medium.

### Description of the Related Art

Conventional monitoring cameras provide a function of detecting an object on a captured video and then determining whether an object is carried away/left behind. A user operates a user interface (UI) that displays a captured video image received from a monitoring camera, and makes settings about detection rules, such as a determination region, an object size to be detected, and a detection sensitivity. The detection region here is a region within a captured video image to determine whether an object is carried away/left behind. Japanese Patent Application Laid-Open No. 2019-169931 discloses a technique of determining whether an object is carried away/left behind with a detection sensitivity and an object size to be detected set in a monitoring camera by a user. Additionally, the monitoring camera that distributes a captured video to a client's device can be controlled with command groups that instruct settings of the detection rules for the monitoring camera from an external device. The Open Network Video Interface Forum (ONVIF) standards established by ONVIF define various kinds of command groups and ONVIF Doc Map describes the outlines of these command groups.

Parameters settable for determination of an object carried away/left behind vary depending on control commands of control protocols, such as ONVIF. Even if the monitoring camera include the settings for detection sensitivity and object sizes to be detected, the control commands may include no object sizes to be detected. If the control commands include no object sizes to be detected, the monitoring camera will operate with its default values for the sizes. For example, if the default value is low for an object size to be detected, the monitoring camera can detect an object which is unintentionally small that is carried away/left behind.

### SUMMARY

According to embodiments of the present disclosure, an imaging apparatus includes a detection unit configured to perform detection for detecting at least one of an object which is carried away and an object which is left behind, a reception unit configured to receive, from an external device, a setting command regarding the detection, and a setting unit configured to set, based on the setting command received by the reception unit, a parameter that is used when the detection unit performs the detection, wherein the setting unit is configured to use a value of a first parameter included in the setting command to set a second parameter that is used when the detection unit performs the detection and that is different from the first parameter.

Further features of the present disclosure will become apparent from the following description of exemplary embodiments with reference to the attached drawings.

### BRIEF DESCRIPTION OF THE DRAWINGS

FIG. 1 is a diagram illustrating the general configuration example of a monitoring system according to an exemplary embodiment.

FIGS. 2A and 2B are diagrams each illustrating a hardware configuration example of an apparatus.

FIGS. 3A and 3B are diagrams each illustrating a functional configuration example of the apparatus.

FIG. 4 is a diagram illustrating an example of control commands of control protocols.

FIG. 5 is a diagram illustrating a setting screen about detection rules for an object carried away.

FIG. 6 is a sequence chart illustrating processing performed by the monitoring system.

FIG. 7 is a flowchart illustrating processing performed by a monitoring camera.

FIGS. 8A to 8C are diagrams each illustrating a setting pattern regarding the detection sensitivity of a camera and the minimum size of an object to be detected.

### DESCRIPTION OF THE EMBODIMENTS

Exemplary embodiments will now be described with reference to the accompanying drawings. According to the present exemplary embodiment, it is possible to appropriately set parameters for detection of an object carried away/left behind on an imaging apparatus using setting commands regarding detection rules received from an external device.

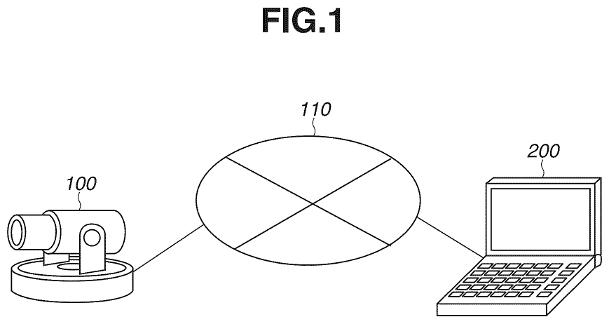

FIG. 1 is a diagram illustrating the general configuration example of a monitoring system according to an exemplary embodiment. As illustrated in FIG. 1, in the monitoring system, a monitoring camera 100 and a client apparatus 200 are connected to each other via a network 110, and transmit/receive information to/from each other. The monitoring camera 100 is installed at a position allowing recording a monitoring target area. The client apparatus 200 transmits, to the monitoring camera 100, control commands including setting commands about rules for detection of an object carried away/left behind in images captured by the monitoring camera 100. The monitoring camera 100 performs various kinds of processing based on control commands received from the client apparatus 200. The monitoring camera 100 transmits, to the client apparatus 200, responses indicating results of the various kinds of processing performed based on the control commands. The monitoring camera 100 is an example of an imaging apparatus. The client apparatus 200 is an example of an external device. The monitoring system is an example of an imaging system.

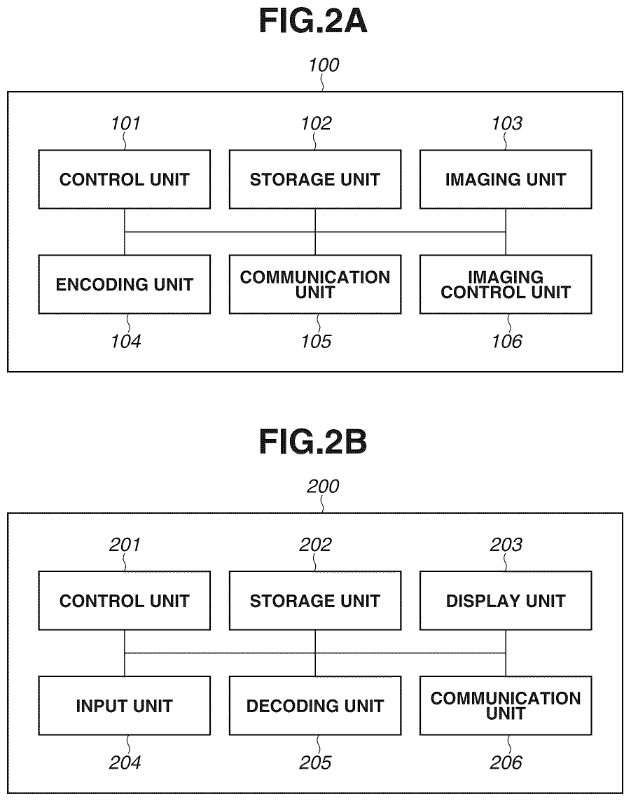

FIG. 2A is a diagram illustrating a hardware configuration example of the monitoring camera 100. As illustrated in FIG. 2A, the monitoring camera 100 includes a control unit 101, a storage unit 102, an imaging unit 103, an encoding unit 104, a communication unit 105, and an imaging control unit 106.

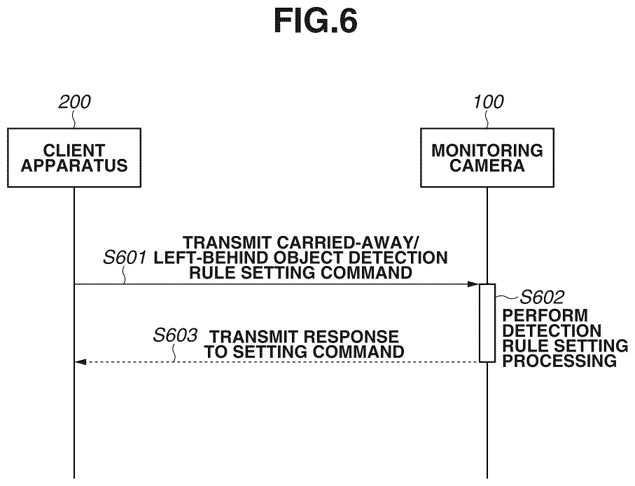

The control unit 101 includes a central processing unit (CPU), and generally controls the monitoring camera 100. The control unit 101 executes programs stored in the storage unit 102, so that the processing in a sequence chart in FIG. 6 described below is performed in the monitoring camera 100.

The storage unit 102 includes a random-access memory (RAM), a read-only memory (ROM), and a hard disk drive (HDD). The storage unit 102 is used as a storage region for programs, a work region used during the execution of a program, a storage region for setting values, such as settings about detection rules, and a storage region for image data from the imaging unit 103, and a storage region for various kinds of data.

The imaging unit 103 captures object images formed by the imaging optical system of the monitoring camera 100 to acquire analog signals, converts the analog signals into digital data, and outputs the digital data as captured images to the storage unit 102. When a captured image is output to the storage unit 102, the control unit 101 receives an image acquisition event from the imaging unit 103.

The encoding unit 104 performs encoding processing on the captured images output from the imaging unit 103 based on a format, such as Joint Photographic Experts Group (JPEG), H.264, and H.265 to generate image data, and outputs the image data to the storage unit 102.

The communication unit 105 is a communication interface for performing communications with an external device, such as the client apparatus 200. The control unit 101 transmits the image data encoded by the encoding unit 104 as a video image via the communication unit 105 to the client apparatus 200.

The imaging control unit 106 controls the panning operation, the tilting operation, or the zooming operation of the imaging unit 103 according to values for panning, tilting, or zooming input from the control unit 101. This changes the imaging region of the imaging unit 103.

FIG. 2B is a diagram illustrating a hardware configuration example of the client apparatus 200. As illustrated in FIG. 2B, the client apparatus 200 includes a control unit 201, a storage unit 202, a display unit 203, an input unit 204, a decoding unit 205, and a communication unit 206.

The control unit 201 includes a CPU, and controls the client apparatus 200. The control unit 201 executes programs stored in the storage unit 202, so that the processing in the sequence chart in FIG. 6 described below is performed in the client apparatus 200.

The storage unit 202 includes a RAM, a ROM, and a HDD. The storage unit 102 is used as a storage region for programs, a work region used during the execution of a program, and a storage region for image data from the monitoring camera 100, a storage region for various kinds of data.

The display unit 203 includes a liquid crystal display (LCD) or an organic electroluminescent (EL) display to display video images received from various kinds of setting user interface (UI) and the monitoring camera 100.

The input unit 204 includes buttons, arrow keys, a touch panel, and a mouse, and notifies the control unit 201 of the details of operations performed by a user.

The decoding unit 205 decodes the encoded image data received via the communication unit 206 based on a format, such as JPEG, H.264, or H.265, and loads the decoded image data in the storage unit 202.

The communication unit 206 is a communication interface for performing communications with the monitoring camera 100. The control unit 201 receives the image data as a video image via the communication unit 105 from the monitoring camera 100.

While the description has been given of the hardware configuration examples of the monitoring camera 100 and the client apparatus 200 with reference to FIGS. 2A and 2B, the monitoring camera 100 and the client apparatus 200 can each include other components, such as a voice input unit and a voice output unit.

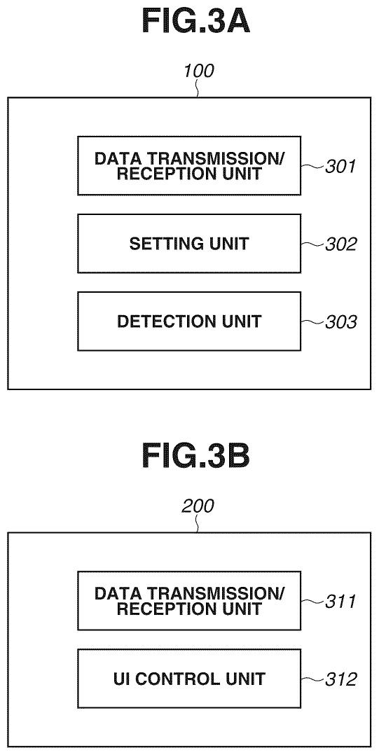

FIG. 3A is a diagram illustrating a functional configuration example of the monitoring camera 100. The monitoring camera 100 functions as a data transmission/reception unit 301, a setting unit 302, and a detection unit 303 by the control unit 101 executing programs stored in the storage unit 102.

When the communication unit 105 receives a command, the data transmission/reception unit 301 receives a command reception event. Additionally, when receiving control commands from the client apparatus 200, the data transmission/reception unit 301 transmits responses to the control commands or video images to the client apparatus 200 via the communication unit 105.

The setting unit 302 uses setting commands for detection rules for an object carried away/left behind received from the client apparatus 200 to set the parameters for the detection of the object carried away/left behind (hereinafter, referred to as “parameters for camera detection”) in the monitoring camera 100.

The detection unit 303 detects an object in a detection region in an imaging region of the imaging unit 103, and determines whether the object is carried away/left behind. The detection unit 303 uses the parameters for camera detection set in the setting unit 302.

FIG. 3B illustrates a functional configuration example of the client apparatus 200. The client apparatus 200 functions as a data transmission/reception unit 311 and a UI control unit 312 by the control unit 201 executing programs stored in the storage unit 202.

The data transmission/reception unit 311 transmits control commands, such as the setting commands for detection rules for an object carried away/left behind via the communication unit 206 to the monitoring camera 100. Additionally, the data transmission/reception unit 311 receives responses to the control commands or video images via the communication unit 206 from the monitoring camera 100.

The UI control unit 312 displays a UI on the display unit 203. The UI control unit 312 controls the viewer screen for video images received from the monitoring camera 100, the setting screen for detection rules, and the display of various kinds of messages.

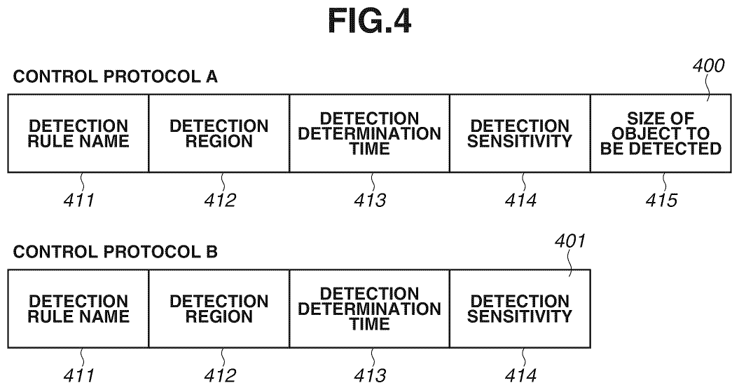

Control commands of control protocols according to the present exemplary embodiment will now be described with reference to FIG. 4. FIG. 4 illustrates control commands 400 and 401, which are the setting commands for detection rules for an object carried away/left behind of control protocols A and B, respectively. The control protocol A can designate a detection rule name 411, a detection region 412, detection determination time 413, detection sensitivity 414, and the size of an object to be detected 415. On the other hand, the control protocol B can designate the detection rule name 411, the detection region 412, the detection determination time 413, and the detection sensitivity 414, but the size of an object to be detected 415.

The detection rule name 411 identifies detection rules. The detection region 412 is a setting value for a region for the detection of an object carried away/left behind, and is designated in the region for imaging in a rectangle. The detection determination time 413 is a setting value for the determination time to determine whether the detected object is carried away/left behind. The detection sensitivity 414 is a setting value for the sensitivity to object detection. The details of the detection sensitivity varies depending on the specifications of a monitoring camera. For example, the detection sensitivity of the monitoring camera 100 represents the difference in luminance between an object and the background when the object is detected. Higher detection sensitivities facilitate the detection of an object but tend to increase the possibility of an erroneous detection.

The size of an object to be detected 415 is a setting value for the size of an object subject to detection of an object carried away/left behind. The details of the size of an object to be detected vary depending on the specifications of a monitoring camera. In some cases, the minimum size alone of an object to be detected is set, or both the minimum and maximum sizes of an object to be detected are set. Additionally, the minimum and maximum sizes are set with an area ratio to a detection region or an imaging region, with a width and a height with respect to an imaging region, or with the same value(s) as a width and a height.

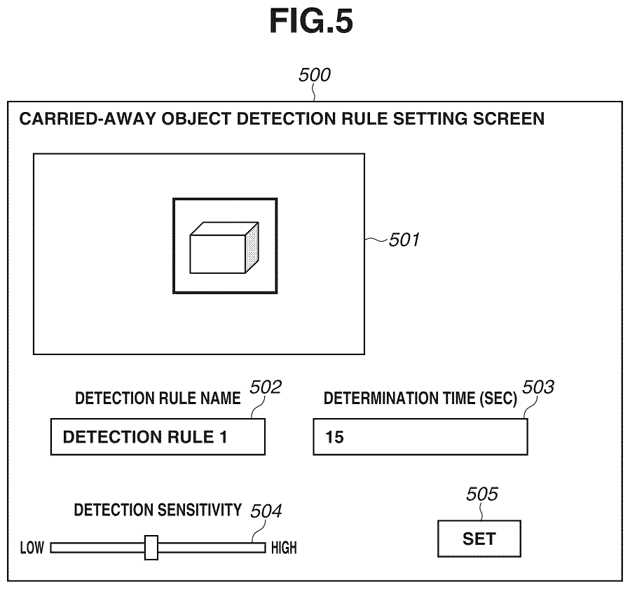

Subsequently, a setting screen for detection rules for an object carried away 500 will be described with reference to FIG. 5. The setting screen 500 is displayed on the display unit 203 of the client apparatus 200 under the control of the UI control unit 312.

A method for setting the parameters for camera detection will be described. The method is used in detection of an object carried away with the control command 401 of the control protocol B not including the size of an object to be detected 415. The setting screen for detection rules for an object carried away 500 is used by a user in designation of setting values of parameters for the control command 401. The setting screen for detection rules for an object carried away 500 includes a detection region setting area 501, text boxes 502 and 503, and a slider 504. A similar setting screen can be used in setting parameters for camera detection for an object left behind.

The detection region setting area 501 displays image data received from the monitoring camera 100. This image region for the image data is the same as that of the imaging unit 103. A rectangular frame for designating the detection region 412 is displayed superimposed on the displayed image data.

The user operates the input unit 204 to designate a plurality of points on the image data in the detection region setting area 501. The UI control unit 312 sets a polygon as the detection region 412 that connects the designated points.

Additionally, the user enters a rule name in the text box 502 and a detection determination time in the text box 503 with the input unit 204, and changes the position of the slider 504 to designate a detection sensitivity. With the use of the slider 504, a desired value can be designated within the setting range of detection sensitivity. The UI control unit 312 sets a value entered in the text box 502 as the detection rule name 411, sets a value entered in the text box 503 as the detection determination time 413, and sets a value designated with the slider 504 as the detection sensitivity 414.

When the user presses a setting button 505, the data transmission/reception unit 311 transmits, via the communication unit 206 to the monitoring camera 100, the setting commands for detection rules including the setting values of parameters designated on the setting screen for detection rules for an object carried away 500.

Subsequently, the processing performed in the monitoring system according to the present exemplary embodiment will be described with reference to the sequence chart in FIG. 6. The monitoring system according to the present exemplary embodiment uses the setting commands for detection rules transmitted from the client apparatus 200 to set the parameters for camera detection used when the monitoring camera 100 determine whether an object is carried away/left behind. The processing of the sequence as illustrated in FIG. 6 is started, for example, when the setting values of the parameters are designated on the setting screen for detection rules for an object carried away 500 displayed on the display unit 203 of the client apparatus 200, and the setting button 505 is pressed.

In step S601, the data transmission/reception unit 311 of the client apparatus 200 transmits to the monitoring camera 100 the setting commands for detection rules for an object carried away/left behind. The data transmission/reception unit 301 of the monitoring camera 100 receives the setting commands for detection rules transmitted from the client apparatus 200.

In step S602, the setting unit 302 of the monitoring camera 100 uses the setting commands for detection rules received in step S601 to set the parameters for camera detection on the monitoring camera 100.

In step S603, the data transmission/reception unit 301 of the monitoring camera 100 transmits the result of setting the detection rules. The data transmission/reception unit 311 of the client apparatus 200 receives the result of setting the detection rules transmitted from the monitoring camera 100.

Then, the processing of the sequence as in the FIG. 6 ends.

Thereafter, the detection unit 303 of the monitoring camera 100 uses the set parameters for camera detection to determine whether the object is carried away/left behind. For example, the detection unit 303 determines that the object is left behind in a determination time in the detection region with the object being detected in the detection region. The detection unit 303 determines that the object is carried away in a determination time after the object becomes undetected in the detection region. The detection region used in the detection unit 303 is set using the value of the detection region 412. Additionally, the determination time used in the detection unit 303 is set using the value of the detection determination time 413.

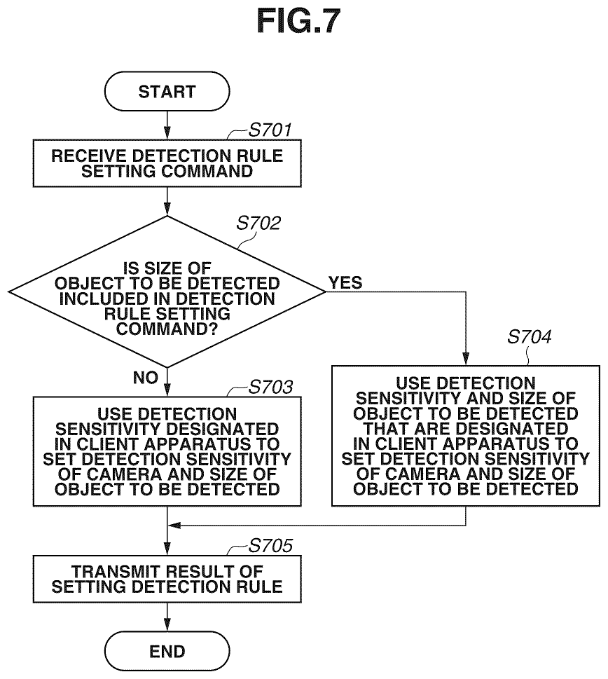

The processing performed on the monitoring camera 100 according to the present exemplary embodiment will be described with reference to FIG. 7. The processing in a flowchart illustrated in FIG. 7 is performed by the control unit 101 executing programs stored in the storage unit 102.

In step S701, the data transmission/reception unit 301 receives the setting commands for detection rules transmitted from the client apparatus 200. The control protocol of the setting commands received in step S701 is not specifically limited, and can be Open Network Video Interface Forum (ONVIF) or a control protocol unique to the monitoring camera.

In step S702, the setting unit 302 checks the parameters included in the setting commands for detection rules received in step S701 to determine whether the detection sensitivity 414 and the size of an object to be detected 415 are included. If the setting unit 302 determines both the detection sensitivity 414 and the size of an object to be detected 415 to be included (YES in step S702), the processing proceeds to step S704. If the setting unit 302 determines the detection sensitivity 414 to be included but the size of an object to be detected 415 to be not (NO in step S702), the processing proceeds to step S703. Otherwise, the setting unit 302 uses the setting values of the parameters included in the setting commands for detection rules to set the parameters for camera detection in the monitoring camera 100, and the processing proceeds to step S705.

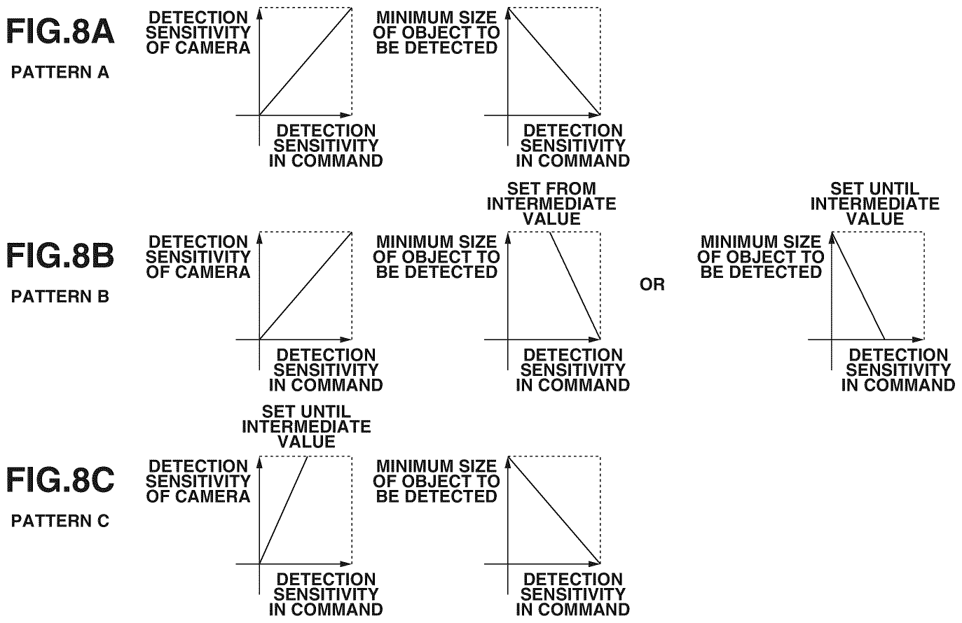

In step S703, the setting unit 302 uses the setting values of the parameters included in the setting commands for detection rules received in step S701 to set the parameters for camera detection in the monitoring camera 100. In this step, since the detection sensitivity 414 is included but the size of an object to be detected 415 is not included in the detection rule setting command, the setting unit 302 uses the value of the detection sensitivity 414 included in the setting commands for detection rules to set a detection sensitivity and the minimum size of an object to be detected, which are used in the detection unit 303. The details of a setting method will be described below with reference to FIGS. 8A to 8C.

In step S704, the setting unit 302 uses the setting values of the parameters included in the setting commands for detection rules received in step S701 to set the parameters for camera detection in the monitoring camera 100. In this step, since the detection sensitivity 414 and the size of an object to be detected 415 are included in the setting commands for detection rules, the setting unit 302 uses the values of the detection sensitivity 414 and the size of an object to be detected 415 included in the setting commands for detection rules to set a detection sensitivity and the size of an object to be detected, which are used in the detection unit 303.

In step S705, the data transmission/reception unit 301 transmits the result of setting the detection rules.

Then, the processing in the flowchart illustrated FIG. 7 ends.

A method for setting a detection sensitivity of the camera and the minimum size of an object to be detected in step S703 in FIG. 7 will now be described with reference to FIGS. 8A to 8C. FIGS. 8A to 8C each illustrate a setting pattern regarding the detection sensitivity of a camera and the minimum size of an object to be detected.

### <Pattern A>

FIG. 8A illustrates a pattern A. The setting unit 302 acquires a value of the detection sensitivity 414 from the setting commands for detection rules, and converts the acquired value into a ratio to a setting range of the detection sensitivity 414. As the ratio obtained through the conversion increases, the setting unit 302 sets a higher detection sensitivity of the camera and a smaller minimum size of an object to be detected.

For example, when the setting range of the detection sensitivity 414 is 0.0 to 1.0 and the value of the detection sensitivity 414 is 0.4, the ratio of the detection sensitivity 414 to the setting range is 40%. On the assumption that the setting range of the detection sensitivity of the camera is 0 to 100, and the minimum size of an object to be detected with the camera is 0 to 100, the setting unit 302 sets the detection sensitivity of the camera at 40. Additionally, the setting unit 302 subtracts 40 from 100, which is the settable maximum value, to set the minimum size of an object to be detected with the camera at 60.

### <Pattern B>

FIG. 8B illustrates a pattern B. In the pattern B, the detection sensitivity of the camera is set in a similar manner to the pattern A. Regarding the minimum size of an object to be detected with the camera, if the value of the detection sensitivity 414 is a threshold or more, the setting unit 302 converts the value of the detection sensitivity 414 to a ratio to a setting range of the detection sensitivity 414, which is settable by the commands, and sets a smaller minimum size of an object to be detected with the camera as the ratio obtained through the conversion increases. Additionally, if the value of the detection sensitivity 414 is less than the threshold, the setting unit 302 sets the minimum size of an object to be detected with the camera at a predetermined value. This pattern is referred to as a pattern B-1. Further, if the value of the detection sensitivity 414 is less than the threshold, the setting unit 302 sets a smaller minimum size of an object to be detected with the camera as the ratio obtained through the conversion increases. If the value of the detection sensitivity 414 is the threshold or more, the setting unit 302 sets the minimum size of an object to be detected with the camera at the predetermined value. This pattern is referred to as a pattern B-2.

First, an example will be described of setting the minimum size of an object to be detected with the camera in the pattern B-1. Suppose the setting range of the detection sensitivity 414, which is settable by the commands, is 0.5 to 1.0, and the minimum size of an object to be detected with the camera is 0 to 100. If the value of the detection sensitivity 414 is 0.7, the ratio of the detection sensitivity 414 to a setting range of 0.5 to 1.0 settable by the commands is 40%. The setting unit 302 subtracts 40 from 100, which is the settable maximum value, to set the minimum size of an object to be detected with the camera at 60. Additionally, if the value of the detection sensitivity 414 is less than 0.5, the setting unit 302 can set the minimum size of an object to be detected with the camera at a settable maximum value.

Subsequently, an example will be described of setting the minimum size of an object to be detected with the camera in the pattern B-2. Suppose the setting range of the detection sensitivity 414, which is settable by the commands, is 0.0 to 0.5, and the minimum size of an object to be detected with the camera is 0 to 100. If the value of the detection sensitivity 414 is 0.2, the ratio of the detection sensitivity 414 to a setting range of 0.0 to 0.5 settable by the commands is 40%. The setting unit 302 subtracts 40 from 100, which is the settable maximum value, to set the minimum size of an object to be detected by the camera at 60. If the value of the detection sensitivity 414 is 0.5 or more, the setting unit 302 can set the minimum size of an object to be detected with the camera at a default value of the camera.

### <Pattern C>

FIG. 8C illustrates a pattern C. In the pattern C, the minimum size of an object to be detected with the camera is set in a similar manner to the pattern A. Regarding the detection sensitivity of the camera, if the value of the detection sensitivity 414 is less than the threshold, the setting unit 302 converts the value of the detection sensitivity 414 to a ratio to a setting range of the detection sensitivity 414, which is settable by the commands, and sets a higher detection sensitivity of the camera as the ratio obtained through the conversion increases. If the value of the detection sensitivity 414 is the threshold or more, the setting unit 302 sets the detection sensitivity of the camera at the predetermined value.

An example will be described of setting the detection sensitivity of the camera in the pattern C. Suppose the setting range of the detection sensitivity 414, which is settable by the commands, is 0.0 to 0.5, and the range of the detection sensitivity of the camera is 0 to 100. If the detection sensitivity 414 is 0.2, the ratio of the detection sensitivity 414 to a setting range of 0.0 to 0.5 settable by the commands is 40%. The setting unit 302 sets the detection sensitivity of the camera at 40. Additionally, if the value of the detection sensitivity 414 is 0.5 or more, the setting unit 302 can set the detection sensitivity of the camera at a default value of the camera.

The setting patterns of the detection sensitivity of the camera and the size of an object to be detected are not limited to the patterns A to C. In addition to the setting of the minimum size of an object to be detected, the setting unit 302 can set the maximum size of an object to be detected with the camera at a settable maximum value. Furthermore, the setting unit 302 can set the minimum size of an object to be detected with the camera in the range between settable minimum and maximum values, or in the range from the default value to the settable maximum value.

The setting unit 302 can receive, from the client apparatus 200 or a user operation, an instruction for selecting a pattern from among the patterns A to C to be used in setting the detection sensitivity of the camera and the size of an object to be detected.

The above-mentioned present exemplary embodiment allows the size of an object to be detected with the camera to be appropriately set in the setting commands for detection rules for an object carried away/left behind received from the external device even when the parameter of the detection sensitivity is included but the parameter of the size of an object to be detected is not. This prevents an erroneous detection of an object carried away/left behind, the detection of which is not intended by a user.

In the present exemplary embodiment, if the size of an object to be detected settable when the monitoring camera 100 performs detection is not included in the setting commands for detection rules from an external device, the detection sensitivity included in the setting commands is used to set the detection sensitivity of the camera and the size of the object to be detected. The detection sensitivity is an example of a first parameter, and the size of an object to be detected is an example of a second parameter. The first and second parameters are not particularly limited as long as the parameters are parameters used in the detection of an object carried away/left behind.

In the present exemplary embodiment, if the detection sensitivity 414 is included but the size of an object to be detected 415 in step S702 in FIG. 7 is not, the setting unit 302 uses the detection sensitivity 414 to set the detection sensitivity of the camera and the size of an object to be detected, but the above-described condition is not limited thereto.

The setting unit 302 can check the control protocol of the setting commands received in step S701 in FIG. 7, and, if the control protocol satisfies the condition of a predetermined control protocol (for example, the control protocol B in FIG. 4), the setting unit 302 can use the detection sensitivity 414 to set the detection sensitivity of the camera and the size of an object to be detected. Additionally, if the control protocol does not satisfy the condition of a predetermined control protocol (for example, the control protocol A in FIG. 4), the setting unit 302 can use the detection sensitivity 414 and the size of an object to be detected 415 to set the detection sensitivity of the camera and the size of an object to be detected. In this manner, the setting unit 302 can perform different processing depending on the difference in control protocol of the setting commands.

Other exemplary embodiments will be described. While the present disclosure includes the exemplary embodiment, the above-described exemplary embodiment is merely an embodiment example of implementing features of the present disclosure, and the technical scope of the present disclosure should not be interpreted in a limited manner by the exemplary embodiment. Thus, embodiments of the present disclosure can be implemented in various modes without departing from the technical idea or the principal features of the present disclosure.

Embodiments of the present disclosure can also be implemented by a process where programs that carry out one or more functions of the above-mentioned exemplary embodiment are supplied to a system or an apparatus through a network or a storage medium, and one or more processors in the system or a computer of the apparatus load and run the programs. Furthermore, embodiments of the present disclosure can also be implemented by a circuit (e.g., an application specific integrated circuit (ASIC)) that carries out one or more functions.

The disclosure of the above-described exemplary embodiments includes the following configurations, method, and program.

### (Configuration 1)

An imaging apparatus comprising:
a detection unit configured to perform detection for detecting at least one of an object which is carried away and an object which is left behind;
a reception unit configured to receive, from an external device, a setting command regarding the detection; and
a setting unit configured to set, based on the setting command received by the reception unit, a parameter that is used when the detection unit performs the detection,
wherein the setting unit is configured to use a value of a first parameter included in the setting command to set a second parameter that is used when the detection unit performs the detection and that is different from the first parameter.

### (Configuration 2)

The imaging apparatus according to the configuration 1, wherein the setting unit is configured to:
in a case where the setting command satisfies a predetermined condition, use the value of the first parameter included in the setting command to set the first and second parameters; and
in a case where the setting command does not satisfy the predetermined condition, use a value of the second parameter included in the setting command to set the second parameter.

### (Configuration 3)

The imaging apparatus according to the configuration 2, wherein the predetermined condition is that the setting command includes the first parameter and does not include the second parameter.

### (Configuration 4)

The imaging apparatus according to the configuration 2, wherein the predetermined condition is that the setting command is a command of a predetermined control protocol.

### (Configuration 5)

The imaging apparatus according to any one of the configurations 1 to 4, wherein the first parameter is a detection sensitivity to the object, and the second parameter is a size of the object to be detected.

### (Configuration 6)

The imaging apparatus according to the configuration 5, wherein the second parameter is a minimum size of the object to be detected.

### (Configuration 7)

The imaging apparatus according to any one of the configurations 1 to 6, wherein the setting unit is configured to set a smaller minimum size of the object to be detected by the detection unit as the detection sensitivity to the object included in the setting command increases.

### (Configuration 8)

The imaging apparatus according to any one of the configurations 1 to 7, wherein the setting unit is configured to:
in a case where the detection sensitivity to the object included in the setting command is less than a threshold, set a smaller minimum size of the object to be detected by the detection unit as the detection sensitivity to the object included in the setting command increases; and
in a case where the detection sensitivity to the object included in the setting command is the threshold or more, set the minimum size of the object to be detected by the detection unit at a predetermined value.

### (Configuration 9)

The imaging apparatus according to any one of the configurations 1 to 7, wherein the setting unit is configured to:
in a case where the detection sensitivity to the object included in the setting command is a threshold or more, set a smaller minimum size of the object to be detected by the detection unit as the detection sensitivity to the object included in the setting command increases; and
in a case where the detection sensitivity to the object included in the setting command is less than the threshold, set the minimum size of the object to be detected by the detection unit at a predetermined value.

### (Configuration 10)

The imaging apparatus according to any one of the configurations 1 to 9, wherein the setting unit is configured to set a minimum size of the object to be detected by the detection unit in a range from a default value to a maximum value settable by the setting unit.

### (Configuration 11)

The imaging apparatus according to any one of the configurations 1 to 10, wherein the setting unit is configured to use the detection sensitivity to the object included in the setting command to set the minimum size of the object to be detected by the detection unit, and set a maximum size of the object to be detected by the detection unit at the maximum value settable by the setting unit.

### (Configuration 12)

The imaging apparatus according to any one of the configurations 1 to 11, wherein the setting unit is configured to designate the size of the object to be detected by the detection unit with an area ratio to an object detection region or an imaging region, or a width and a height in the object detection region or the imaging region.

### (Method)

A method for controlling an imaging apparatus, the method comprising:
performing detection for detecting at least one of an object which is carried away and an object which is left behind;
receiving, from an external device, a setting command regarding the detection; and
setting, based on the received setting command, a parameter that is used in the detection,
wherein the setting includes using a value of a first parameter included in the setting command to set a second parameter that is used when the detection is performed and that is different from the first parameter.

### (Program)

A non-transitory computer-readable storage medium storing a program that causes a computer of an imaging apparatus to function as:
a detection unit configured to perform detection for detecting at least one of an object which is carried away and an object which is left behind;
a reception unit configured to receive, from an external device, a setting command regarding the detection; and
a setting unit configured to set, based on the setting command received by the reception unit, a parameter that is used when the detection unit performs the detection,
wherein the setting unit is configured to use a value of a first parameter included in the setting command to set a second parameter different from the first parameter to be used when the detection unit performs the detection.

According to the exemplary embodiments, parameters to be used in the detection of an object carried away/left behind can be appropriately set with setting commands for detection rules for an object carried away/left behind received from an external device.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-205387, filed Dec. 5, 2023, which is hereby incorporated by reference herein in its entirety.

What is claimed is:

1. An imaging apparatus comprising:
one or more processors; and
one or more memories storing instructions that, when executed by the one or more processors, cause the one or more processors to function as:
a detection unit configured to perform detection for detecting at least one of an object which is carried away and an object which is left behind;
a reception unit configured to receive, from an external device, a setting command regarding the detection; and
a setting unit configured to set, based on the setting command received by the reception unit, a parameter that is used when the detection unit performs the detection,
wherein the setting unit is configured to use a value of a first parameter included in the setting command to set a second parameter that is used when the detection unit performs the detection and that is different from the first parameter.

2. The imaging apparatus according to claim 1, wherein the setting unit is configured to:
in a case where the setting command satisfies a predetermined condition, use the value of the first parameter included in the setting command to set the first parameter and the second parameter; and
in a case where the setting command does not satisfy the predetermined condition, use a value of the second parameter included in the setting command to set the second parameter.

3. The imaging apparatus according to claim 2, wherein the predetermined condition is that the setting command includes the first parameter and does not include the second parameter.

4. The imaging apparatus according to claim 2, wherein the predetermined condition is that the setting command is a command of a predetermined control protocol.

5. The imaging apparatus according to claim 1, wherein the first parameter is a detection sensitivity to the object, and the second parameter is a size of the object to be detected.

6. The imaging apparatus according to claim 5, wherein the second parameter is a minimum size of the object to be detected.

7. The imaging apparatus according to claim 5, wherein the setting unit is configured to set a smaller minimum size of the object to be detected by the detection unit as the detection sensitivity to the object included in the setting command increases.

8. The imaging apparatus according to claim 5, wherein the setting unit is configured to:
in a case where the detection sensitivity to the object included in the setting command is less than a threshold, set a smaller minimum size of the object to be detected by the detection unit as the detection sensitivity to the object included in the setting command increases; and
in a case where the detection sensitivity to the object included in the setting command is the threshold or more, set the minimum size of the object to be detected by the detection unit at a predetermined value.

9. The imaging apparatus according to claim 5, wherein the setting unit is configured to:
in a case where the detection sensitivity to the object included in the setting command is a threshold or more, set smaller minimum size of the object to be detected by the detection unit as the detection sensitivity to the object included in the setting command increases; and
in a case where the detection sensitivity to the object included in the setting command is less than the threshold, set the minimum size of the object to be detected by the detection unit at a predetermined value.

10. The imaging apparatus according to claim 5, wherein the setting unit is configured to set a minimum size of the object to be detected by the detection unit in a range from a default value to a maximum value settable by the setting unit.

11. The imaging apparatus according to claim 5, wherein the setting unit is configured to use the detection sensitivity to the object included in the setting command to set a minimum size of the object to be detected by the detection unit, and set a maximum size of the object to be detected by the detection unit at a maximum value settable by the setting unit.

12. The imaging apparatus according to claim 5, wherein the setting unit is configured to designate the size of the object to be detected by the detection unit using an area ratio to an object detection region or an imaging region, or a width and a height in the object detection region or the imaging region.

13. A method for controlling an imaging apparatus, the method comprising:
performing detection for detecting at least one of an object which is carried away and an object which is left behind;
receiving, from an external device, a setting command regarding the detection; and
setting, based on the received setting command, a parameter that is used in the detection,
wherein the setting includes using a value of a first parameter included in the setting command to set a second parameter that is used when the detection is performed and that is different from the first parameter.

14. A non-transitory computer-readable storage medium storing one or more programs including instructions, which when executed by a computer of an imaging apparatus, cause the imaging apparatus to:
perform detection for detecting at least one of an object which is carried away and an object which is left behind;
receive, from an external device, a setting command regarding the detection; and
set, based on the setting command, a parameter that is used in the detection,
wherein the setting includes using a value of a first parameter included in the setting command to set a second parameter that is used when the detection is performed and that is different from the first parameter.
